(19) United States
(12) Patent Application Publication
(10) Pub. No.: US 2013/0002879 A1
(43) Pub. Date: Jan. 3, 2013

(54) SYSTEMS AND METHODS FOR TRACKING A COMMODITY

(75) Inventor: Michael Weber, Denver, NC (US)

(73) Assignee: SENSORMATICS ELECTRONICS, LLC, BOCA RATON, FL (US)

(21) Appl. No.: 13/175,047

(22) Filed: Jul. 1, 2011

(51) Int. Cl. H04N 7/18; G08B 13/14

(52) U.S. Cl. 348/159; 340/572.1; 348/E07.085

(57) ABSTRACT

A system for monitoring articles within a monitored area is provided. The system for monitoring articles within a monitored area comprises tags configured to be coupled to articles. The tags have GPS transceivers and RF transmitters therein. The RF transmitters transmit RF data. The RF data transmitted from the RF transmitters uniquely identify the corresponding tag. The system for monitoring articles within a monitored area also includes RF sensors configured to be distributed data over a monitored area. The RF sensors receive the RF data received from the RF transmitters. The system for monitoring articles within a monitored area further includes GPS sensors configured to be positioned to cover the monitored area. The GPS sensors and GPS transceivers convey GPS data there between. The system for monitoring articles within a monitored area also includes a processor module to identify movement of the articles within the monitored area based on the RF data. The processor module tracks movement of the articles within the monitored area based on the GPS data.

### BACKGROUND OF THE INVENTION

The subject matter disclosed herein relates to surveillance and more particularly to systems and methods for surveillance of a commodity.

Over the years, may electronic article surveillance or anti-shoplifting systems have been devised for detecting the unauthorized removal of articles from an area under protection. Electronic Article Surveillance (“EAS”) systems are detection systems that allow the detection of a marker or tag within a given detection region. EAS systems have many uses; however, most often they are used as security systems to prevent shoplifting from stores or removal of property from office buildings. EAS systems come in many different forms and make use of a number of different technologies. A typical EAS system includes an EAS detection unit, markers and/or tags, and a detacher or deactivator.

The detection unit includes transmitter and receiver antennas and is used to detect any active markers or tags brought within the range of the detection unit. The antenna portions of the detection units can, for example, be bolted to floors as pedestals, buried under floors, mounted on walls, or hung from ceilings. The detection units are usually placed in high traffic areas, such as entrances and exits of stores or office buildings. The deactivators transmit signals used to detect and/or deactivate the tags. The markers and/or tags have special characteristics and are specifically designed to be affixed to, or embedded in, merchandise or other objects sought to be protected.

Electronic articles surveillance systems generally create an electromagnetic field within a limited space called an interrogation zone through which the articles to be protected must pass. Attached to the protected article is a specific element called a marker. The marker is designed to interact in a particular way with the electromagnetic interrogation field to create a signal that is unique to the system. This so called marker signal is such that its presence can be detected by circuitry located in the electronic article surveillance system. This circuitry continually scans the interrogation zone looking for the marker signal and generates an alarm when one is found.

Most EAS systems operate using the same general principles. The detection unit includes one or more transmitters and receivers. The transmitter sends a signal at defined frequencies across the detection region. For example, in a retail store, placing the transmitter and receiver on opposite sides of a checkout aisle or an exit usually forms the detection region. When a marker enters the region, it creates a disturbance to the signal being sent by the transmitter. As an alternative to the basic design described above, the receiver and transmitter units, including their respective antennas, can be mounted in a single housing.

EAS detectors, in general are not reliable. For example, a growing method to defeat electronic article surveillance (“EAS”) systems is the use of readily available metal foils such as aluminum foil to shield EAS markers from detection by an EAS system. Thieves often line the insides of shopping bags, handbags and backpacks with metal foil to provide a concealed compartment for placing items to be stolen while inside the store so that they can exit through the detection zone of an EAS exit systems without detection. In response to this problem, retailers are increasingly using metal detection systems tuned to detect metal foil so that they can be alerted if a foil lined bag or backpack passes through the exit.

A problem with such approach is that merchandise, such as a case of soda cans, can mimic the response of a foil-lined bag due to surface area similarities and trigger false alarms. Thus, the presence of legitimately purchased items may affect the overall reliability of the EAS system. False alarms from metal detectors detract from the merchants' confidence and hurt sales of such systems.

Another problem with EAS system is that an EAS system is not linked to a video surveillance system. Video surveillance systems typically include a series of cameras placed in various locations about an area of interest (e.g., a warehouse, a retail establishment, an office building, an airport, for example). The cameras transmit video feeds back to a central viewing stations (or multiple stations), typically manned by a security officer. The various surveillance feeds are displayed on a series of screens, which are monitored for suspicious activities. However, such video surveillance systems are not capable of tracking individual articles.

Another problem with EAS systems is that most EAS systems operate using the same general principles. The detection unit includes one or more transmitters and receivers. The transmitter sends a signal at defined frequencies across the detection region. The EAS system fails to disclose the location of the article being monitored precisely.

As the EAS system becomes more complex, there is an additional need for sustained power supply. While, sustained power supply is needed, the power supply unit's size should be small so as to fit within the tag housing.

There exists, therefore, a need for systems and techniques that will provide for low cost, high performance EAS systems.

### BRIEF DESCRIPTION OF THE INVENTION

In accordance with one embodiment, systems and methods for monitoring articles within a monitored area is provided. The systems and methods for monitoring articles within a monitored area comprise tags configured to be coupled to articles. The tags have GPS transceivers and RF transmitters therein. The RF transmitters transmit RF data. The RF data transmitted from the RF transmitters uniquely identify the corresponding tag. The systems and methods for monitoring articles within a monitored area also include RF sensors configured to be distributed data over a monitored area. The RF sensors receive the RF data received from the RF transmitters.

The systems and methods for monitoring articles within a monitored area further includes GPS sensors configured to be positioned to cover the monitored area. The GPS sensors and GPS transceivers convey GPS data there between. The systems and methods for monitoring articles within a monitored area also include a processor module to identify movement of the articles within the monitored area based on the RF data. The processor module tracks movement of the articles within the monitored area based on the GPS data.

In one embodiment, the systems and methods the RF transmitters and sensor are RFID transmitters and sensors. Alternatively, the RF transmitters and sensor are EAS transmitters and sensors. In another embodiment, the articles are stored on shelves and the RF sensors are located proximate to the shelves, the RF sensors to detect when the articles are removed from the shelves.

In one embodiment, the processor module, within the systems and methods begins tracking movement of a first article utilizing the GPS data in response to the identification that the first article is moving based on the RF data. Alternative embodiment of The systems and methods may further comprising surveillance cameras having corresponding fields of view that cover at least partially non-overlapping portions of the monitored area. The processor module of the systems and methods may be configured to select one of the surveillance cameras and create a log including an image segment from the selected surveillance camera based on the GPS data.

In another embodiment of the systems and methods described in the subject matter herein, the systems and methods may further include a deactivation module. The deactivation module may be operated by authorized personnel. The deactivation module may identify articles that are approved for removal from the monitored area. The deactivation module may transmit signal to the network. The processor module may cease tracking movement of the article upon receipt of a deactivation instruction from the deactivation module.

The processor module may be configured to set an alarm condition when the GPS data indicates that the article has been removed from the monitored area. In one embodiment of the systems and methods described in the subject matter herein, the systems and methods may also include a charging device to recharge tags when removed from articles.

The systems and methods described herein may also allow the tag to be tamper proof. In one embodiment of the systems and methods, the processor module may set an alarm condition indicative of the interruption of RF data and/or the GPS data. In another embodiment of the systems and methods, may include log that may contain image segment including video content and/or still image content from the surveillance cameras.

### BRIEF DESCRIPTION OF THE DRAWINGS

The drawings illustrate generally, by way of example, but not by way of limitation, various embodiments discussed in the present document.

FIG. 1A illustrates a retail store with a surveillance system formed in accordance with an embodiment.

FIG. 1B illustrates boundaries of a plurality of cameras defining camera zones within the monitored area in accordance with an embodiment.

FIG. 2A is a block diagram of a tag formed in accordance with an embodiment.

FIG. 2B is a block diagram of a sensor formed in accordance with an embodiment.

FIG. 3A is a block diagram of a processor module 36 formed in accordance with an embodiment.

FIG. 3B illustrates a database log formed in accordance with an embodiment.

FIG. 3C illustrates creation of a video and a still picture log from the surveillance camera feed in accordance with an embodiment.

FIG. 4 is a process flow chart illustrating the roles of each participant in a supply chain for tracking and monitoring assets formed in accordance with an embodiment.

FIG. 5 is a flowchart of an asset tracking process formed in accordance with an embodiment.

### DETAILED DESCRIPTION OF THE INVENTION

The foregoing summary, as well as the following detailed description of certain embodiments of the subject matter set forth herein, will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the terms “a” or “an” are used, as is common in patent documents, to include one or more than one. In this document, the term “or” is used to refer to a nonexclusive or, unless otherwise indicated.

As used herein, relational terms, such as “first” and “second,” “top” and “bottom,” and the like, may be used solely to distinguish one entity or element from another entity or element without necessarily requiring or implying any physical or logical relationship or order between such entities or elements. Further, “Wi-Fi” refers to the communications standard defined by IEEE 802.11. “Ethernet” refers to the communication standard defined by IEEE 802.3. The term “WiMAX” means the communication protocols defined under IEEE 802.16. “BLUETOOTH” refers to the industrial specification for wireless personal area network (“PAN”) communication developed by the Bluetooth Special Interest Group.

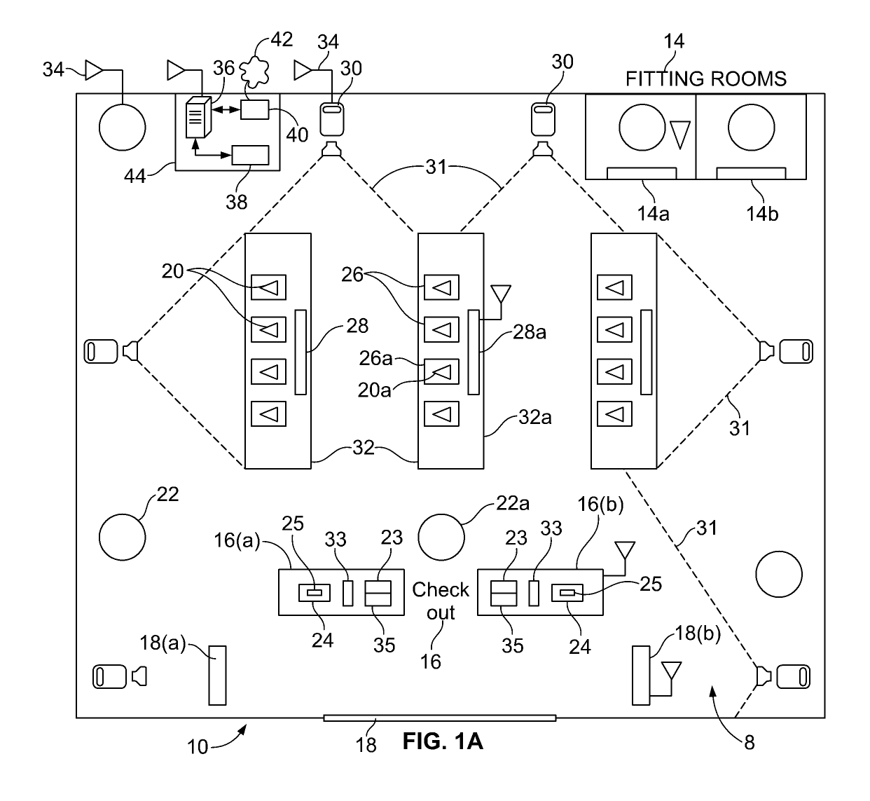

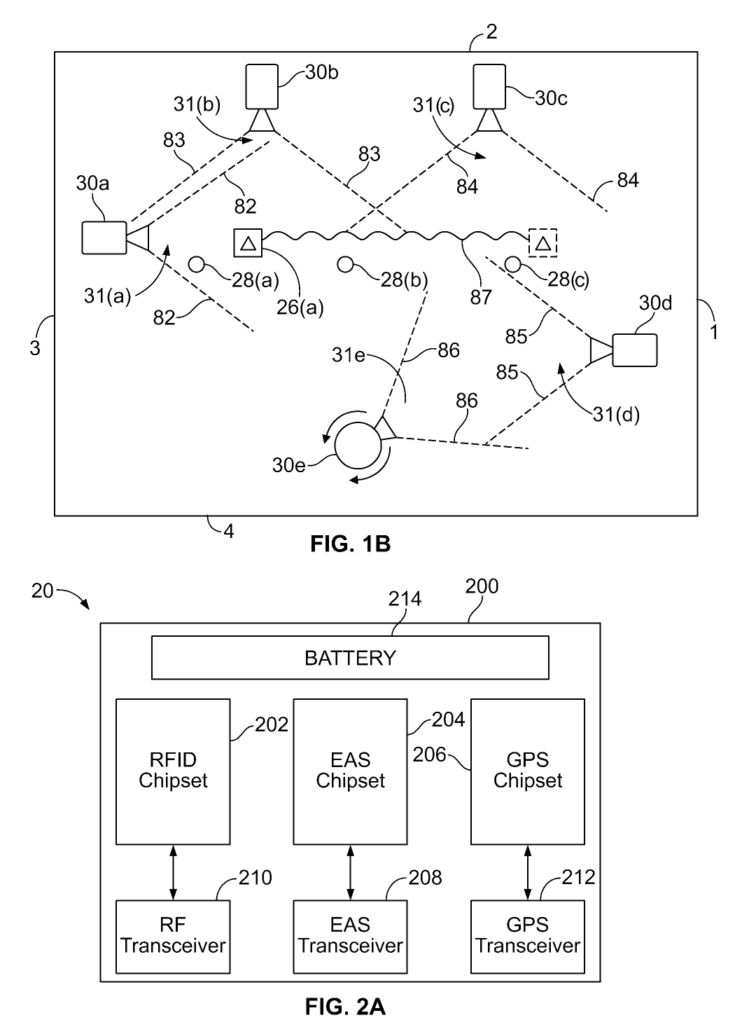

FIG. 1A illustrates a surveillance system 8 in accordance with an embodiment. The surveillance system 8 is at least partially located in a monitored area 10. For example, the monitored area 10 may be a retail establishment including private regions such as fitting rooms 14 with fitting units 14a and 14b, and a checkout station 16 having cashiers and associated checkout stations 16a and 16b. An exit area 18, providing exit from the monitored area 10, has exit detection units 18a and 18b. The monitored area 10 includes articles storage regions, such as shelves 32, which retain a plurality of articles 26. The articles 26 have tags 20 attached thereto.

The surveillance system 8 may also includes cameras 30 that records an individual who may remove an article 26 from the shelf. For example, the cameras 30 may capture a video signal and/or still images of the individual. The surveillance system 8 may also include a network 34 connecting the sensors 22, 28 and the exit detection units 18a and 18b with each other and with a processor module 36, configured to process data received from the sensors 22, 28 and/or exit detection units 18a and 18b.

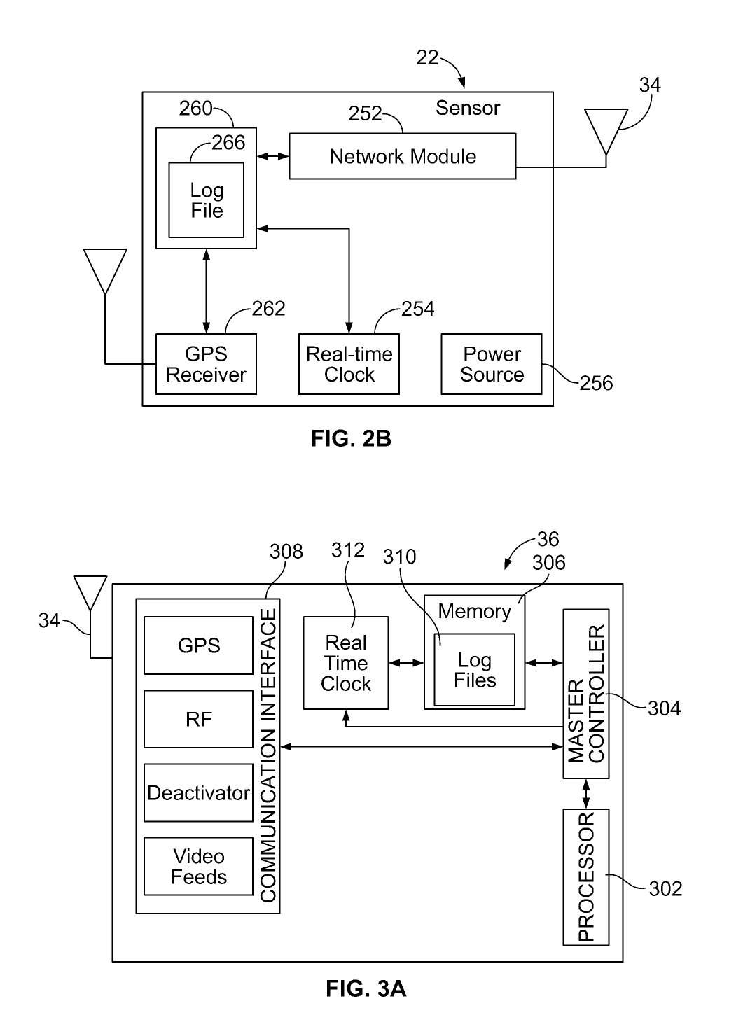

In accordance with one embodiment, the surveillance system 8 monitors movement of the articles 26 by sensing and tracking the tags 20 coupled to articles 26, within the monitored area 10. FIG. 2A is a block diagram of a tag 20 formed in accordance with an embodiment. The tag 20 includes a housing 200 that may house an RFID chip set 202, an EAS chip set 204 and a GPS chip set 206. Optionally, the tag 20 may include the EAS chip set 204 and the GPS chip set 206. Alternatively, the tag 20 may includes the RFID chip set 202 and the GPS chip set 206.

The RFID chip set 202 may have a hardwired unique identifier that the RFID chip set 202 may communicate to uniquely identify the corresponding tag 20. The GPS chip set 206 may use location information to estimate the physical location of the tag 20 within the monitored area 10. Optionally, the GPS chip set 206 may be configured to receive data from satellites to determine the location of the tag 20 after the tag 20 may have been removed from the monitored area 10

The tag 20 may also have a GPS transceiver 212 and RF transceivers 208, 210 for transmitting and receiving the GPS data and RF data respectively. The RF transceivers 208, 210 may transmit RF data and the GPS transceiver may transmit the location coordinate of the tags 20. For example, the EAS chip set 204 and the RFID chip set 202 may communicate with the sensors 22, 28 when placed in proximity to the sensors 22, 28. Additionally, the tags 20 may have a power source 214 to provide operating energy for the RFID chip set 202, the EAS chip set 204, and the GPS chip set 206. For example, the power source may be a lithium-ion battery.

In one embodiment, the surveillance system 8 includes multiple sensors 22 and 28 distributed through out and/or about the perimeter of the monitored area 10. The sensors 22, 28 may send and receive various combinations of EAS, RF, and/or GPS data to and from the tags 20 respectively. Alternatively, the sensors 22, 28 may send and receive only one of the EAS, RF, or GPS data to and from the tags 20 respectively. In one embodiment the tag 20 may communicate RF data to the sensor 28, wherein sensor 28 may be an RFID sensor. Optionally, the RF data from the tag 20 may be communicated to the exit detection units 18a and 18b. Alternatively, the sensors 22 and the tags 20 may only convey GPS data therebetween.

FIG. 2A is a block diagram of a sensor 22 formed in accordance with an embodiment. The sensor 22 includes a GPS receiver 262 to receive the tag's 20 GPS coordinates. The sensor 22 may also include a real time clock 254 to generate a time stamp, wherein the time stamp comprises the time at which each of the GPS co-ordinates are received by the sensor 22. Both, the GPS co-ordinates and their corresponding time stamps may be stored in a log file 266 within a memory 260. The memory 260 may be a volatile memory, a non-volatile memory, or a combination thereof.

The sensor 22 may further include a network module 252 that may facilitate connection between a sensor 22 and the network 34. The network module 252 may send the log file 266 to the processor module 36 or a data storage unit 40 in response to a command received over the network 34. The sensor 22 may also include a power source 256 which provides operating power to the sensor 22. The power source may be a battery or a D.C. power supply or an A.C. power supply. In one embodiment, the sensor 22 may also include an RFID transceiver to communicate RF data between the sensor 22 and the tags 20. The RF data may be stored in the log file 266 along with a time stamp created by the real time clock 254.

The combination EAS/RFID/GPS security tag 20 may be coupled to articles 26 placed on shelves 32. The shelves 32 may be placed within the monitored area 10 to form aisles there between for shoppers to walk. The sensor 28 may be located proximate to the shelve 32 so that the sensor 28 may communicate with the tags 20. For example, the sensor 28a may be placed on the shelf 32a. The sensors 28 may receive RF data from the tags 20, wherein the received RF data may be used to detect when the articles 26 may be placed on the shelves 32 and/or when the articles 26 may be removed from the shelves 32.

The network 34 communicates with the sensors (22, 28) and other modules of the surveillance system 8 to collect tracking data. The network 34 connects plurality of sensors (22, 28) and the exit detection units 18a, 18b to the processor module 36. The processor module 36 may identify movement of the articles 26 within the monitored area 10 based on the received RF data. Also, the processor module 36 tracks movement of the articles 26 within the monitored area 10 based on the received GPS data. In one embodiment, the processor module 36 may track movement of a first article 26(a) using the GPS data in response to the identification that the first article 26(a) may be removed from the shelf 32(a) based on the received RF data.

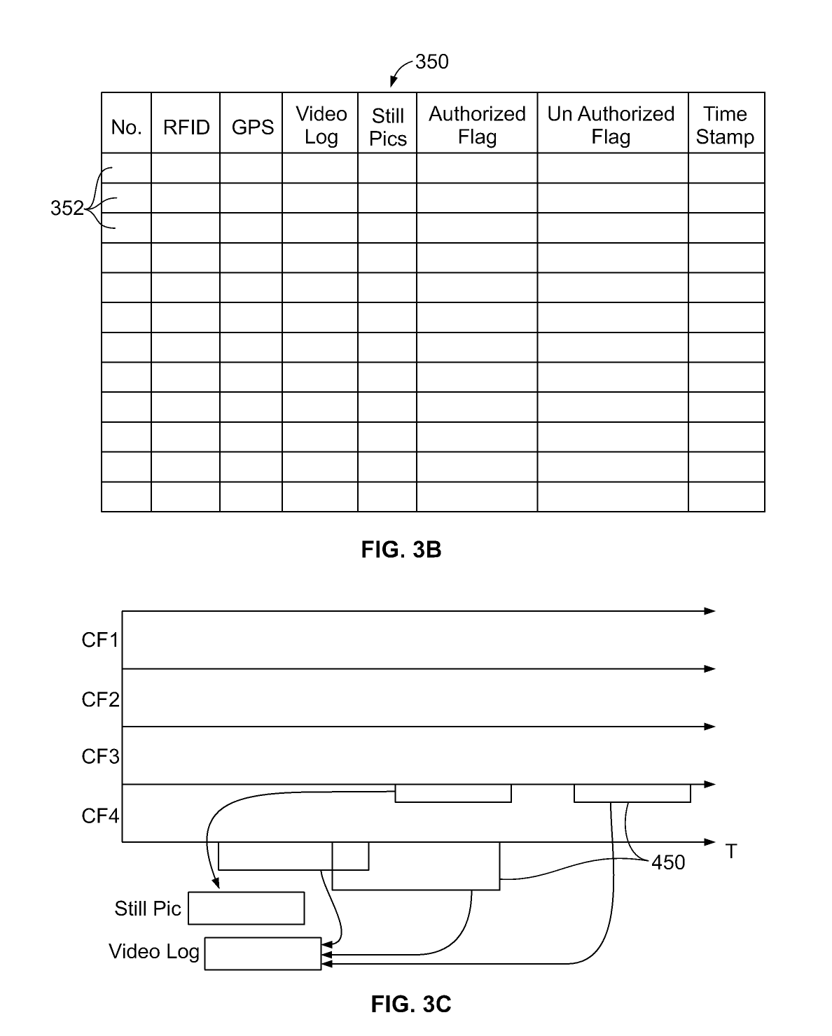

FIG. 3A is the block diagram of the processor module 36 in accordance with an embodiment. The processor module 36 include a communication interface 308 that is used to communicate with the individual sensors (22, 28), the deactivation module 33, the exit detection units (18a, 18b), barcode scanner 35 and the surveillance camera 30 to receive tracking information for the articles 26. The processor module 36 may include a processor 302 communicatively coupled to a master controller 304. The master controller 304 may control the working of the processor module 36 base on the instruction received from the processor 302. The processor 302 may store instructions for storing, organizing and analyzing data received from the individual sensors (22, 28), the deactivation module 33, the exit detection units (18a, 18b) and the surveillance camera 30.

The processor module 36 may also include a memory 306. The memory 306 may be used to store information locally; including a log files 310 containing data from individual sensors (22, 28), deactivation module 33 and surveillance camera 30. The memory 306 may be a non-volatile memory, including but are not limited to, a hard drive, a memory stick, an Electrically Erasable Programmable Read-Only Memory (“EEPROM”), a flash memory, etc. Additionally, instead of or in addition to non-volatile memory, the memory 306 may be included as some form of volatile memory, e.g., RAM.

The processor module 36 may communicate with the sensors (22, 28), the deactivation module 33, the exit detection units (18a, 18b), barcode scanner 35 and the surveillance camera 30 over a network 34. Alternatively, sensors (22, 28), the deactivation module 33, the exit detection units (18a, 18b), barcode scanner 35 and the surveillance camera 30 may communicate with each other. The data may be communicated within the network 34 using any combination of commonly used wired and/or wireless communication protocols such as Transmission Control Protocol/Internet Protocol (“TCP/IP”), Time Division Multiple Access (“TDMA”), Global System for communications (“GSM”), General Packet Radio Service (“GPRS”), Enhanced Data Rates for GSM Evolution (“EDGE”), Third Generation Protocols (“3G”), 4G, EvDO, CDMA, Ethernet, Wi-Fi, WiMAX, BLUETOOTH, etc.

The surveillance system 8 may integrate tag detection and tracking with the surveillance cameras 30. FIG. 1B illustrates boundaries 82-86 for a plurality of cameras 30a-30e defining camera zones 31 within the monitored area 10 in an embodiment. The cameras 30a-30e may have a fixed camera zone 31d or a rotating camera zone 31e, with stationary or moving boundaries 82-86. The surveillance cameras 30a-30e each have a corresponding camera zone 31a-31e, wherein the camera zone 31a-31e at least partially covers non-overlapping regions of the monitored area 10. Alternatively, the surveillance cameras 30a-30e may have camera zones 31a-31e with overlapping parts of the monitored area 10. For example, the fixed zone cameras 30a-30d may be mounted on the perimeter walls 1, 2, 3, 4 of the monitored area 10. For example, the rotating zone camera 31e may be mounted on the ceiling of the monitored area 10 wherein each rotating zone camera 31e may look down over the monitored area 10. For example, the monitored area 10 that may not be covered by the fixed zone cameras 31a-31d may be covered by the rotating cameras 31e. The surveillance cameras 30a-30e may capture at least one of video or still images of the monitored area 10. Additionally, the surveillance cameras 30a-30e may provide multiple active real-time video feeds to the surveillance system 8.

The surveillance cameras 30a-30e may be positioned and oriented to cover monitored area 10. When a person removes the article 26a, coupled with the tag 20a, from the shelf 32a the processor module 36 may detect such movement based on the log received from the RF sensor 28a. The processor module 36 may have a correlation information between the sensors 22, 28 and the cameras 30a-30e. The correlation information relates a surveillance camera to a sensor 22, 28 reporting article movement such that the processor module 36 uses the related camera to receive the camera feed. For example, when the RF sensor 28a reports a movement of the article 26a, the processor module 36 may use the camera feed received from the camera 30a, wherein the camera 30a may be selected based on the correlation information.

A person carrying the article 26a may move within the monitored area 10. The RF sensors 28a may report movement which may be used by the processor module 36 to receive a camera feed from camera 30a. The camera feed from the camera 30a covers the camera zone 31(a) defined by the boundaries 82. As the article 26a is moved from the camera zone 31(a) to the camera zone 31(b), the sensor 28(b) triggers the processor module 36 to a used camera feed from camera 30b to get visual information about the article 26a. As the article 26a moves along the path 87, the processor module 36 recognizes that the article 26a crosses boundaries 82-86, and based on these boundary crossings obtains a video feed from a new corresponding camera 31a-31e.

Alternatively, the processor module 36 may maintain a library with coordinate information for the boundaries 82, 84, 85. The library may have a coordinate map of the monitored area 10 with boundary information for each surveillance camera 31a-31e and the respective preference for a camera feed to be used when the article 26a is in an overlapping region. The coordinate information may be used by the processor module 36 in combination with the GPS data received from the sensors 22. As the article 26a moves along the path 87 within the monitored area, the sensors 22 may relay GPS coordinate information for the article 26a. The processor module 36 may select a camera feed based on the coordinate data of the article 26a within the monitored area 10.

The processor module 36 may be configured to select one of the surveillance cameras 30 and create a log including an image segment or video segment from the selected surveillance camera 30. Furthermore, the image segments and/or video segments may be selected based on the GPS data. FIG. 3C illustrates creation of a video and a still picture log from the surveillance camera feed in accordance with an embodiment. CF1, CF2, CF3 etc represent the plurality of camera feeds that the processor module 36 may receive via the communication interface 308. For example, the camera feeds CF1, CF2, and CF3 may represent the feeds received from cameras 30a, 30b, and 30c respectively. The master controller 304, upon receiving instructions form the processor 302 may select a segment of a surveillance camera feed. For example, for surveillance camera 30a, the master controller may select camera feed CF1. The selection of the segment may be based on the article 26 being monitored. As the article 26 moves within the monitored area, the tag 20 may relay GPS coordinates to the processor module 36. The processor may use the received GPS coordinates to select from the plurality of cameras 30 the segment which contains visual information about the article 26 in real time.

In one embodiment the communication interface 308 controls the exchange of information between the processor module 36 and a data collection server 40 over a wide area network (WAN) 42. The wide area network 42 may include the Internet, intranet, personal area networks (“PANs”), local area networks (“LANs”), campus area networks (“CANs”), metropolitan area networks (“MANs”), etc. The data collection servers 40 may store a consolidated tracking data received from the sensors (22, 28), the deactivation module 33, the exit detection units (18a, 18b), barcode scanner 35 and the surveillance camera 30 over a network 34. The processor module 36 may use the consolidated tracking data to detect the article 26 activity within the monitored area 10.

The data collection server 40 may be located in a surveillance room 44 within the monitored area 10. Alternatively, the data collection server 40 may be located in a remote location. In one embodiment, the data collection server may communicate with the central data collection server through the WAN 42 that may store tracking information of articles from a plurality of monitored areas.

The data collection servers 40 include one or more collection databases or may be communicatively coupled to one or more external centralized databases. The databases in one embodiment may store the log file generated by the processor module 36. FIG. 3B illustrates a database log formed in accordance with an embodiment. The database log or the log file may store serial number (No.) for the individual article. The database log or the log file may also store RFID and GPS data, including but not limited to tag number, coordinate information etc. In one embodiment, the database log may also store information regarding authorization flag, un-authorization flag depicting whether the article 26 was removed from the monitored area 10 with or without authorization. Additionally, the database log may also store time information received from the real time clock 312 on either the processor module 36 or the sensors 22, 28. In one embodiment, the database log may store segments selected by the processor module 36 which contains visual information about the article 26 in real time.

The processor module 36 may be configured to set an alarm condition when the GPS data indicates that the article has been removed from the monitored area 10. For example, the alarm may be triggered when the article may be removed from the monitored area 10 without the tag 20 being deactivated by deactivation module 33. For example, the processor module 36 may detect any interruption in the transmission of the at least one of RF data and/or the GPS data associated with an individual article. In one, the processor module 36 may set an alarm condition indicative of the interruption of RF data and/or the GPS data. The alarm may be communicated using the user interface 38. Alternatively, the user interface 38 may allow a user to communicate with the processor module 36.

The surveillance system 8 includes checkout stations 16a and 16b where the articles 26 may be checked out for authorized removal. For example, the checkout stations 16a and 16b may be a cashier's stand where customers pay for the purchased articles. The checkout stations 16a and 16b may include a detacher 23 to uncouple the tags 20 from the articles 26. For example, the tag 20 may be attached to clothing articles 26 using a pin attachment mechanism. The pin attachment mechanism may be removed by a detacher 23 that may employ a magnetic means to release the pin. The detacher 23 may read RF and GPS data from the tag 20 when the tag 20 is removed from the article 26. Optionally, to enable the removal of the pin the detacher 23 may first read and verify the RFID stored in the tag 20. For example, to detach the pin the cashier may place the end of the tag 20 in a defined region of the detacher 23.

The checkout stations 16a and 16b may include a barcode scanner 35. The tags 20 may communicate the unique RFID using the RF data. Additionally, the RFID may be printed on the tag as a barcode. In one embodiment, the barcode scanner 35 may be used instead of an electronic RF data reader to read the RFID tag 20. Checkout stations 16a and 16b may include a deactivation module 33. The deactivation module 33 may convey tag-related data to the processor module 36 to identify articles 26 that are approved for removal from the monitored area 10. The deactivation module 33 may transmit the tag-related data over a wired or wireless network. For example, the deactivation module 33 may send the RFID of the tags 20 along with a signal confirming approved removal of the tags 20 to the processor module 36.

The checkout stations 16a and 16b may also include a storage module 24 for storing the tags 20 after the tags 20 have been decoupled from the articles 26. Checkout stations 16a and 16b may also have a charging device 25 to recharge the tags 20. For example, the tags 20 may be recharged in the storage module 24, after the tags 20 have been decoupled from the article 26. For example, the storage area 24 may provide conduits where the tags 20 may be placed. Current may be applied to the tags 20 when placed in such conduits, to recharge the tags 20.

The subject matter described herein may allow the tag 20 to be tamper proof. For example, an article 26a coupled to a tag 20a may be placed inside a bag that may shield the tag 20a from communicating RF and/or GPS data to the sensors 22, 28. The processor module 36 detects the break in communication between the tag 20a and the sensors 22, 28. Upon detecting such break in communication, the processor module 36 may raise alarm and alert a user of the surveillance system 8. Optionally, if the communication between the tag 20a and the sensors 22, 28 is disrupted for any other reason, the surveillance system 8 may respond by alerting the user.

Alternatively, when the tag 20a coupled to an article 26a is removed from the monitored area 10 without authorized deactivation; the tag 20a may stop communicating RF data to the sensors 22, 28. However, the GPS data may still be communicated between the tag 20a and the sensors 22. Thus, when the processor module 36 detects the break in communication, the processor modules 36 queries the sensors 22 and the camera 30 for the GPS log files and live camera feeds. The processor module 36 uses the GPS coordinate within the log files to provide the location of the tag 20a to the user of the surveillance system 8 or to local law enforcement.

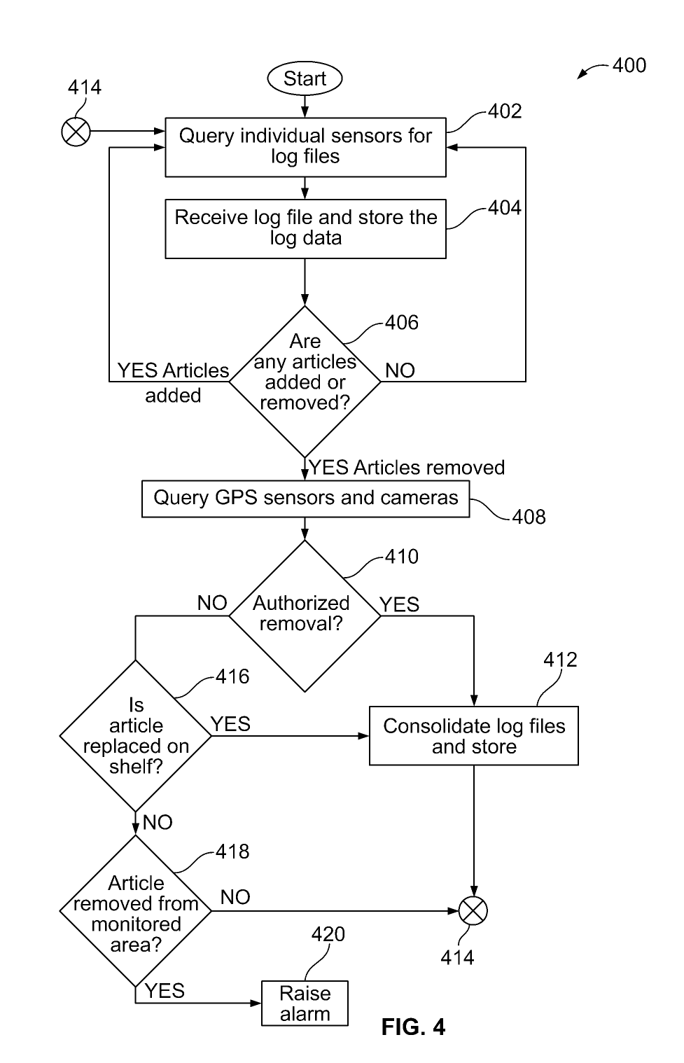

FIG. 4 is a flowchart illustrating article tracking process 400 implemented using the surveillance system 8 in accordance with an embodiment. At 402, the processor module 36 queries individual sensors 22, 28 for log files 310 to detect removal or addition of articles 26 from the shelves 32. For example, the processor module 36 may query the sensors 22, 28 for RFID data. For example, the processor module 36 may query the sensor 22a for the log files 310 to detect if the article 26a coupled to the tag 20a have been removed from the shelf 32a.

Flow moves to 404, where the processor module 36 receives the log file 310 and stores the data presented in the log file 310. In one embodiment, the storage process may involve storing the log file 310 in a local memory 306. For example, the processor module 36 may identify log files for the article 26a using a unique identifier. For example, when the processor module 36 receives a log file 310, the processor module replaces the last stored file identified with the unique article identifier with the new log file 310. Alternatively, the processor module 36 may store all log files within the memory which may be identified using a unique identifier and a time stamp designating a new in time file.

Optionally, the entire log file 310 may be parsed and data from the parsed log file may be updated into a database. The database may have a master table having a row designated to all articles in the stores inventory. Each row of the master table may also have the unique identifier for each of the articles 26 in the stores inventory. Each row referring to the unique identifier for an article may be further linked to a second table which may contain the columns as described in FIG. 3B. All articles may each have a linked second table 350 which stores the activity of the articles 26 within the monitored area 10. For example, the rows 352 in FIG. 3B may be the rows of second table 350 where the tracking information such as RFID, GPS, video logs, still pictures, authorization flag, time stamp and the like may be stored. The database used may be MySQL, MSSQL, Oracle, Access and the like.

At 406, the processor module 36 checks the log files 310 for articles 26 that may be added and/or removed from the shelves 32 based on the RFID data. For example, the RFID sensors 28a may monitor the tags 20 placed on the shelf 32a and generate a log file 310 that includes all the unique identifiers for the tags 20 present. When the processor module 36 receives the log file 310 from the RFID sensor 28a, the processor module parses the log file 310 for the unique identifiers and compares them with the unique identifiers received in the last log file. By comparing the new log file with the last log file, the processor module may determine the articles 26 that may be added and/or removed from the shelf 32. Alternatively, the processor modules may have a macro running which parses the new log file and stores it in the data base and then queries the database for the new articles 26 added and/or removed.

If new articles are added or no articles removed from the shelf 32a, the flow moves back to 402 and the loop (402,406) starts again. However, if an articles is removed from the shelf 32a, the processing module 36 queries sensor 22a for GPS data and the cameras 30 for visual data. For example, the processor module 36 may query multiple GPS sensors 22 for log files 310. Optionally, the processor modules may query one GPS sensor 22a for log files 310. Also at 408, the processor modules 36 queries the camera 30 for the live camera feeds CF1-CF4. For example, the live camera feeds may be more than four feeds. Optionally, the processor module 36 may query only one camera 30 for live feed.

The cameras 30a-30e may have a fixed camera zone 31d or a rotating camera zone 31e, defined based on the boundaries 82-86. The surveillance cameras 30a-30e may each have a corresponding camera zone 31a-31e, wherein the camera zone 31a-31e at least partially covers non-overlapping parts of the monitored area 10. Alternatively, the surveillance cameras 30a-30e may have camera zones 31a-31e with overlapping parts of the monitored area 10.

The surveillance cameras 30a-30e may be positioned and oriented to cover monitored area 10. When a person removes the article 26a, coupled with the tag 20a, from the shelf 32a, the processor module 36 may detect such movement based on the log received from the RF sensor 28a. The processor module 36 may have correlation information between the sensors 22, 28 and the cameras 30a-30e. The correlation information relates a surveillance camera to a sensor reporting article movement such that the processor uses the related camera to receive the camera feed.

Alternatively, the processor module 36 may have a library with boundaries 82-86 coordinate information. The library may have a coordinate map of the monitored area 10 with boundary information for each surveillance camera 30a-30e and the respective preference for a camera feed to be used when the article 26a is in an overlapping region. The coordinate information may be used by the processor module 36 in synchronization with the GPS data received from the sensors 22. As the article 26a moves along the path 87 within the monitored area, the sensors 22 may relay GPS coordinate information for the article 26a. The processor module 36 may select a camera feed based on the coordinate data of the article 26a within the monitored area 10.

The processor module 36 uses the GPS coordinate within the log files 310, received from the GPS sensors 22a, for the identified tag 20a to track the article's 26a location. Also, the GPS coordinates within the log files 310 may be used to select video segments 450 from the live camera feed CF1-CF4. When the article 26a is within the bounds of monitored area 10, the video feeds may be used to extract segments containing visual information for the article 26a. The visual information may be displayed on a surveillance monitor placed in a surveillance room to be viewed by a user of the surveillance system 8.

In one embodiment, the GPS data may be continuously received from the sensors 22 until the surveillance system 8 confirms that the article 26a has been replaced on the shelf 32a or has been authorized for removal from the monitored area 10. For example, the article 26a may be removed from the shelf 32 by a customer to purchase the article 26a by taking the article to a cashier at the checkout station 16. Optionally, when the article may be a clothing article, the customer may remove the article to the private region such as one of the fitting units 14a and 14b to test the fitting of the clothing article.

At 410, the process 400 determines when the article 26a may be authorized for removal from the monitored area 10. In one embodiment, the tag 20a may be deactivated by an authorized person using the deactivation module 33. For example, the article 26a may be purchased at the checkout stations 16a, 16b. Alternatively, the article 26a may be authorized for removal as a replacement for a defective article. Optionally, the article 26a may be deactivated and removed from the monitored area for any reason.

When the tag 20a is deactivated, the deactivation module 33 may relay the deactivation information and the tag's 20a unique identifier to the processor module 36 via the network 34. The processor module 36 upon receipt of the deactivation information and the tag's 20a unique identifier, update the database table linked to the unique identifier to set an authorized removal flag. When the authorized removal flag is set, the processor module 36 may remove the article 26a from a monitored list.

After the tag 20a may be deactivated and detached from the article 26a, the tag 20a may be placed in the storage module 24. The storage module 24 stores the tags 20 after the tag 20a has been decoupled from the articles 26a. For example, the storage module 24 may be part of the checkout stations 16a and 16b. Alternatively, the storage module 24 may be at a place outside the monitored area 10. While placed in storage modules 24 the tag 20a may be charged using a charging device 25.

The flow moves to 412, where the process 400 involves consolidating the log files 310. The consolidation process may involve appending all the log files for the article 26a into a single log file. Alternatively, the consolidation process may involve parsing information from the log file and updating the information in a database tables followed by removing any redundant information stored within the database tables. The flow moves along to loop at junction 414 which take the process back to step 402. The loop at junction 414-402 repeats and the tracking process continuously monitors the articles 26 within the monitored area 10.

Returning to flow at 410, when the article 26a has not been authorized for removal, the flow moves to 416. At 416, the process 400 determines whether the article 26a has been replaced back on the shelf 32a. For example, the article 26a may be placed back on the shelf 32a. Optionally, the article 26a may be placed on another shelf 32b other than 32a. In one embodiment, the processor module may query all RFID sensors 28 for log files 310. The processor module 36 may search for the unique identifier for the tag 20a in these log files 310. When the processor module 36 finds the unique identifier in the log files 310, the processor module 36 determines which RFID sensor 28 communicated the log file. Alternatively, the log files from all the RFID sensors 28 may be received by the processor module 36 and update into the database. The processor module 36 may use a macro designed to look for articles 26 that may be replaced on to a different shelves. The flow moves to 412, where the process 400 involves consolidating the log files 310 and the process starts again at 402.

Returning to flow at 416, the process 400 moves to 418 where the process performs another check to determine whether the article 26a may be removed from the monitored area 10 or taken beyond the checkout station 16 coordinates. The processor module 36 may use the GPS coordinates received from the sensor 22 to determined the position of the article 26a. For example, the processor module 36 may compare the coordinate of the four corners of the monitored area 10 with the received coordinate of the article 26a to determine if the article is within the bounds of the monitored area 10.

When the article 26a is removed from the monitored area or taken beyond the checkout station 16 line without authorization, the flow moves to 420. At 420, upon determination that the article 26a has been removed from the monitored area or taken beyond the checkout station 16 line, the processor module 36 raises an alarm and alerts the user of the surveillance system 8. For example, the alert may be an SMS signal to phones of all the employees at duty. Optionally, the alert may be a light and/or an audio signal in the surveillance room 44 located within the monitored area 10. Another option may be a light and/or an audio signal in a surveillance room located outside the monitored area 10. Alternatively, the alert may be a light or an audio signal relayed to the local law enforcement or a private security.

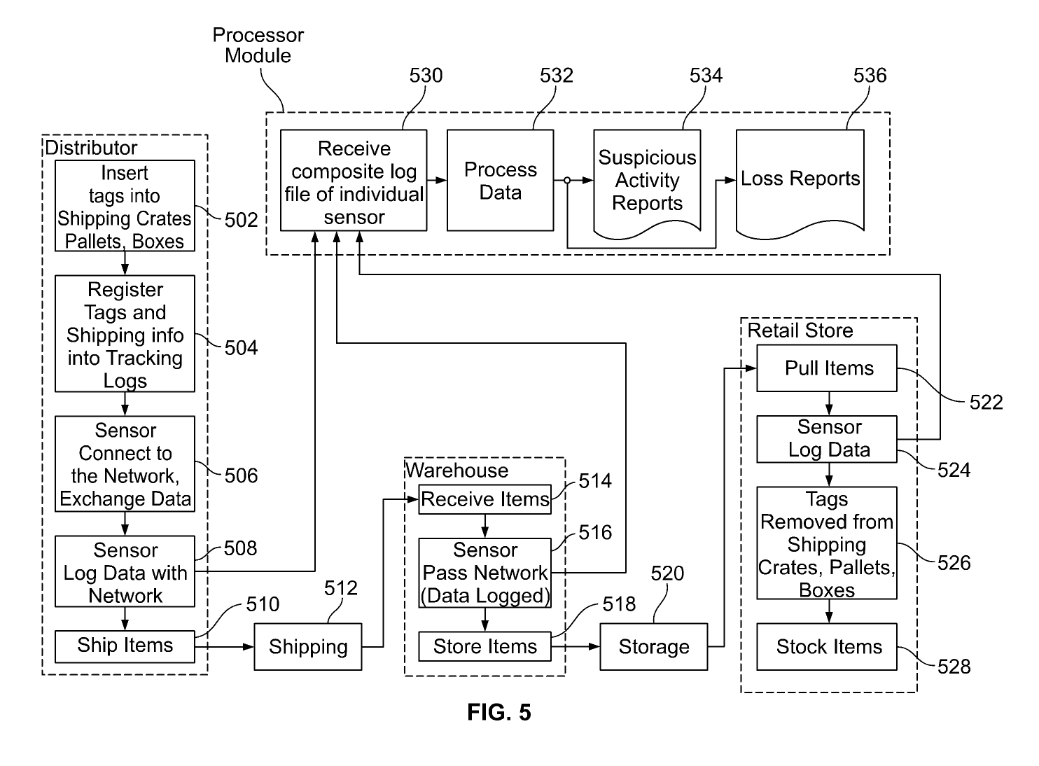

FIG. 5 is a flow chart illustrating tracking and monitoring of articles in an entire supply chain for in accordance with an embodiment. At 502 a distributor inserts the tags 20 into merchandise shipping containers, pallets or cases. At 504, the sensors 22, 28 register the tags 20 into a database of the central data collection server 40 with information relating to the corresponding merchandise with which they are shipped. At 506, the process includes the sensors 22, 28 exchanging status data over a network 34 which begins recording information about the presence and status of the tags 20 and other sensors 22, 28 in the detectable vicinity. At 508, the sensors 22, 28 may be read by a processor module 36. The flow then moves to 510, where the process involves storing product information into a log prior to shipment.

At 512, the process includes continuous communication between tags 20 and sensors 22, 28 and among sensors 22, 28 and collectively storing information about the presence and status of tags 20 and other sensor 22, 28 in the detectable vicinity. Further, the on-board sensors 22, 28 may be used by the processor module 36 to detect changes in the conditions of the packaging to determine if the packaging may be tampered with during shipment. This information may also be stored in the sensors 22, 28 to detect tampering.

At 514, the shipment may be received at the warehouse. The process moves along, at 516 the sensors 22, 28 are read by the processor module 36 and the data that may be stored may be logged into a database. At 518, the shipment may then be sent to storage.

At 520, when the shipment is in storage, the sensors 22, 28 may continue to communicate periodically with one another and with the tags 20, again collectively storing information about the presence and status of other sensors 22, 28 in the vicinity. Again the on-board sensors 22, 28 may be used to detect changes in conditions of the packaging to detect tampering. At some point, the merchandise may be removed from storage and sent to the retailer or the monitored area 10 of FIG. 1.

At 522, shipping containers are pulled so that the items may be sold. Again at 524, the sensors 22, 28 are read by processor module 36 and the data may be logged into the database. At 526 the process may involve removing the tags 20 from the shipping crates, pallets or case packaging and sending the tags 20 back to the distributor for reuse during the next shipment. The flow moves along and at 528 the individual articles 26 are then stocked on the retailer's shelves 32 for sale with new set of tags 20 that may identify the individual articles 26.

At 530, the data collection server 40 receives data from the processor module 36. The received data may include a composite log of data collected from individual sensors 22, 28. At 532, the processor module 36 processes the data from the individual sensors 22, 28 to detect anomalies or other data that suggest theft or tampering of tags 20. At 534, the process involves analyzing the composite log data to generate suspicious activity reports. Alternatively, the process involves analyzing the composite log data to generate loss records at 536. The report may include the time, type of event, GPS location data, and other useful information about when a loss or suspicious activity occurred during shipment and/or storage.

One embodiment of the present invention includes provisions to allow the sensors 22, 28 to conserve power by operating in a sleep mode during periods when little activity may be occurring. However, the systems and methods may be able to wake up when important events occur.

The subject matter disclosed herein can be realized in hardware, software, or a combination of hardware and software. Any kind of computing system, or other apparatus adapted for carrying out the methods described herein, may be suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system may be able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A system for monitoring articles within a monitored area, the system comprising:
tags configured to be coupled to articles, the tags having GPS transceivers and RF transmitters therein, the RF transmitters transmitting RF data uniquely identifying the corresponding tag;
RF sensors configured to be distributed over a monitored area, the RF sensors receiving the RF data received from the RF transmitters;
GPS sensors configured to be positioned to cover the monitored area, the GPS sensors and GPS transceivers conveying GPS data there between; and
a processor module to identify movement of the articles within the monitored area based on the RF data, the processor module to track movement of the articles within the monitored area based on the GPS data.

2. The system of claim 1, wherein the RF transmitters and sensor are RFID transmitters and sensors.

3. The system of claim 1, wherein the RF transmitters and sensor are EAS transmitters and sensors.

4. The system of claim 1, wherein the articles are stored on shelves and the RF sensors are located proximate to the shelves, the RF sensors to detect when the articles are removed from the shelves.

5. The system of claim 1, wherein the processor module begins tracking movement of a first article utilizing the GPS data in response to the identification that the first article is moving based on the RF data.

6. The system of claim 1, further comprising surveillance cameras having corresponding fields of view that cover at least partially non-overlapping portions of the monitored area, the processor module to select one of the surveillance cameras and create a log including an image segment from the selected surveillance camera based on the GPS data.

7. The system of claim 1, further comprising a deactivation module, operated by authorized personnel, to identify select articles that are approved for removal from the monitored area, the processor module to cease tracking movement of the article upon receipt of a deactivation instruction from the deactivation module.

8. The system of claim 7, wherein the image segment includes video content and/or still image content for a region in which a select tag is located.

9. The system of claim 1, the processor module to set an alarm condition when the GPS data indicates that the article has been removed from the monitored area.

10. The system of claim 1, further comprising a charging device to recharge tags when removed from articles.

11. The system of claim 1, wherein the processor module detects an interruption in at least one of the RF data and the GPS data associated with an individual article, and sets an alarm condition indicative of the interruption.

12. A method for monitoring articles within a monitored area, the method comprising:
providing tags to be coupled to articles, wherein the tags having GPS transceivers and RF transmitters therein, the RF transmitters transmitting RF data uniquely identifying the corresponding tag;
configuring RF sensors to be distributed over a monitored area, the RF sensors receiving the RF data received from the RF transmitters;
configuring GPS sensors to be positioned to cover the monitored area, the GPS sensors and GPS transceivers conveying GPS data there between;
identifying movement, using a processor module, of the articles within the monitored area based on the RF data;
tracking movement of the articles within the monitored area based on the GPS data.

13. The method of claim 12, wherein the RF transmitters and sensor are RFID transmitters and sensors.

14. The method of claim 12, wherein the RF transmitters and sensor are EAS transmitters and sensors.

15. The method of claim 12, further comprising storing the articles on shelves, locating the RF sensors proximate to the shelves, and detecting when the articles are removed from the shelves by the RF sensors.

16. The method of claim 12, wherein the tracking movement of a first article begins in response to an identification that the first article is moving based on the RF data.

17. The method of claim 12, further comprising providing surveillance cameras having corresponding fields of view that cover at least partially non-overlapping portions of the monitored area, selecting one of the surveillance cameras and creating a log including an image segment from the selected surveillance camera based on the GPS data.

18. The method of claim 12, further comprising receiving a deactivation instruction, identifying a select article that is approved for removal from the monitored area, and ceasing to track movement of the article upon receipt of the deactivation instruction.

19. The method of claim 12, further comprising setting an alarm condition when the GPS data indicates that the article has been removed from the monitored area.

20. The method of claim 12, further comprising recharging the tags when removed from articles.

21. The method of claim 12, further comprising detecting an interruption in at least one of the RF data and the GPS data associated with an individual article, and setting an alarm condition indicative of the interruption.

22. The method of claim 12, wherein the image segment includes video content and/or still image content for a region in which a select tag is located.
